(19) United States
(12) Patent Application Publication
(10) Pub. No.: US 2018/0343634 A1
(43) Pub. Date: Nov. 29, 2018

(54) METHOD AND APPARATUS FOR PROVIDING CONTEXT-AWARE SERVICES

(71) Applicant: Alibaba Group Holding Limited, George Town (KY)

(72) Inventors: Zhijun Yuan, Hangzhou (CN); Chunsong Yang, Hangzhou (CN); Fan Wu, Hangzhou (CN)

(21) Appl. No.: 15/993,411

(22) Filed: May 30, 2018

Related U.S. Application Data
(63) Continuation-in-part of application No. PCT/CN2016/107406, filed on Nov. 28, 2016.

(30) Foreign Application Priority Data
Dec. 8, 2015 (CN) 201510898397.5

(51) Int. Cl. H04W 60/04; H04L 29/08; H04W 4/50

(52) U.S. Cl. CPC H04W 60/04; H04L 67/14; H04W 4/80; H04L 67/04; H04W 4/50; H04L 67/16

(57) ABSTRACT

A method for providing context-based services is disclosed, including: receiving, by a service platform, a notification from a first device, the notification including information of a context obtained about a user by the first device; and transmitting, by the service platform, the information of the context to at least one second device such that the at least one second device is triggered to execute a pre-configured service command corresponding to the information of the context, the at least one second device being correlated to the information of the context.

### CROSS REFERENCE TO OTHER APPLICATIONS

This application claims priority to International (PCT) Application No. PCT/CN16/107406 entitled METHOD AND DEVICE FOR PROVIDING SERVICE BASED ON SCENE, filed Nov. 28, 2016 which is incorporated herein by reference for all purposes, which claims priority to China Application No. 201510898397.5 entitled A METHOD AND DEVICE FOR PROVIDING SERVICE BASED ON CONTEXT, filed Dec. 8, 2015 which is incorporated herein by reference for all purposes.

### FIELD OF THE INVENTION

The present application generally relates to the smart device technology and more particularly, to a method and apparatus for providing context-based services.

### BACKGROUND OF THE INVENTION

In the emerging era of the Internet of Things (IoTs), smart devices are deployed in more and more popular applications. To name a few, markets for automated homes, autonomous vehicles, personal wellness programs, and professional healthcare programs are benefiting evolutionarily from the technology of IoTs and the like.

Presently, most smart devices either passively record device-detected information, or are triggered to perform functions only in response to a user's active command. For example, when a user of a smart device clicks on a button on the smart device or operates a GUI item displayed on the smart device, a corresponding command is executed thereon. Additionally, most smart devices are only able to communicate via Bluetooth networks with other smart devices. As a result, a smart device is often only able to serve a user within the confines of its individual sensing capacity, and not able to act in synergy and/or collaboration with other smart devices that are also servicing the user.

Furthermore, most smart devices are configured to obtain the context information related to the course of a user operating such a smart device. For example, a smart bracelet is only configured to monitor the contexts related to a user's physiological and motion data, e.g., whether the user is exercising, walking, or sleeping, when the user is wearing the smart bracelet. As such, smart devices are typically not able to become aware of an overall context of a user to apprehend the contextual information such as the user's current environmental conditions. Using the smart bracelet for example again, a smart bracelet can detect that a user is sleeping based on the monitored data of heart rate date, body temperature and so on, but not the location information with regard to where the user is currently sleeping. As such, the smart bracelet is not able to contribute or participate in actions to control the ambience settings of the environment where the user is currently resting. For example, if the user is resting at a break-room pod at work, the desired action is to wake the user up in 15 minutes. If the user is resting at home, the desired action is to dim the lights if they are above a certain illumination level, lower the sound volume of the audio system, and set the mobile phone in not-disturb mode, etc. The smart bracelets on the market today cannot distinguish between the locations and take appropriate actions.

Therefore, there exists a need of providing users with comprehensive smart services that are more precisely customized to user's contexts and more convenient to use by the user.

### BRIEF DESCRIPTION OF THE DRAWINGS

Various embodiments of the invention are disclosed in the following detailed description and the accompanying drawings.

FIG. 1 is a schematic diagram illustrating an example system of providing context-based services, in accordance with one or more embodiments of the present disclosure.

FIG. 2 is a flow chart illustrating an example process for providing context-based services, in accordance with one or more embodiments of the present disclosure.

FIG. 3 is a schematic diagram illustrating an example of sharing contexts amongst smart devices, in accordance with one or more embodiments of the present disclosure.

FIG. 4 is a functional diagram illustrating an example service platform for providing context-based services, in accordance with one or more embodiments of the present disclosure.

FIG. 5 is a functional diagram illustrating an example first smart device for providing context-based services, in accordance with one or more embodiments of the present disclosure.

FIG. 6 is a functional diagram illustrating an example second device for providing context-based services, in accordance with one or more embodiments of the present disclosure.

FIG. 7 is a functional diagram illustrating an embodiment of a programmed computer system for providing context-based services, in accordance with one or more embodiments of the present disclosure.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A technique for providing context-based services in a flexible and convenient manner is described herein. A service platform is configured to provide context-based services and to enable collaboration and synergized actions amongst devices that are in communication therewith. As a result, devices are configured to provide services customized to a user's overall context. The service platform is configured based on various contexts of a user, thereby achieving the inter-connection amongst devices to realize the sharing of various contexts obtained at various devices with each other, and to service the user based on the knowledge of the overall contexts of the user.

The term “context of a user” or “user context” or “context” as used herein refers to information pertaining to the circumstances a user is in, or the circumstances under which a user is operating a device and/or an application. A user context can be determined based on a variety of factors. A user context can be obtained or derived based on user factors including, for example, behaviors or actions or operations of a user, or physiology data of the user. A user context can also be obtained or derived from environmental factors including, for example, time, location, temperature, humidity, breaking news, popular consumer demands, stock market conditions, etc. A description for a particular context can be configured in advance and optimized subsequently. In some embodiments, a context identifier and a general description can be pre-configured for a particular context, and a context sub-identifier and a more specific description with more details can be configured later. For example, a context can be tagged as “USER_SLEEP” with the description as “the user is currently sleeping,” which can be later updated into a sub-context tagged as “USER_SLEEP_AT_HOME” with the description also updated as “the user is currently sleeping at home.”

The term “Internet of Things” (IoT) as used herein refers to the technology implementing the architecture that a large number of objects (e.g., device), not limited to computers or computer networks, can be readable, recognizable, locatable, and controllable via a network (e.g., the Internet). Example objects of an IoT network can include a variety of information-gathering devices such as RFID equipped devices, infrared sensor equipped devices, global positioning systems (GPS) equipped devices, laser scanner equipped devices, and the like. In the age of ubiquitous connectivity of things, terminal devices of users are becoming increasingly diverse to include devices with screens, devices without screens, household devices, wearable devices, and the like.

The term “device” or “smart device” as used herein refers to a single device, or a component of a device, or a composite device having multiple components, or the like. A device can also be a legacy device adapted with the IoT capabilities. For example, a device can include a mobile phone, a computer, a smart household device, a wearable device, a smart medical device, an in-vehicle device, etc. A mobile phone device can include, for example, a smart phone or a conventional flip-phone. A computer device can include, for example, a server computer, a personal computer, a notebook computer, a tablet computer, and the like. A smart household device can include, for example, a smart television set, a smart air-conditioning system, a smart humidifier, a smart water heater, a smart kitchen appliance, a smart ventilation system (e.g. a smart door and a smart window), a smart air purifier, a smart home security system, and the like. A wearable device can include, for example, a smart watch, a pair of smart glasses, a smart wrist-band, a piece of smart clothing, smart shoes, smart accessories, and the like. A smart medical device can include, for example, a smart blood pressure gauge, a smart bodyweight scale, a smart blood sugar meter, a smart massage seat, a smart bio-metrics monitor, and the like. An in-vehicle device can include, for example, a smart on-board information system for traffic information, cellular communication, vehicle diagnosis, navigation system, warning system, emergency system, entertainment system, and the like.

According to various embodiments of the present disclosure, smart devices are configured to communicate the contexts detected thereon with each other through a service platform. As such, a smart device becomes knowledgeable about an overall context of a user, the overall context being determined based on the collective contexts gathered from the smart devices. Further, a smart device can also be configured to execute service commands corresponding to triggering contexts, providing the user with services more tailored to the user context. This way, the efficiency and effectiveness of the context-based services is enhanced, the expenditure of computing resources on repeated context detecting performed by the smart devices is reduced.

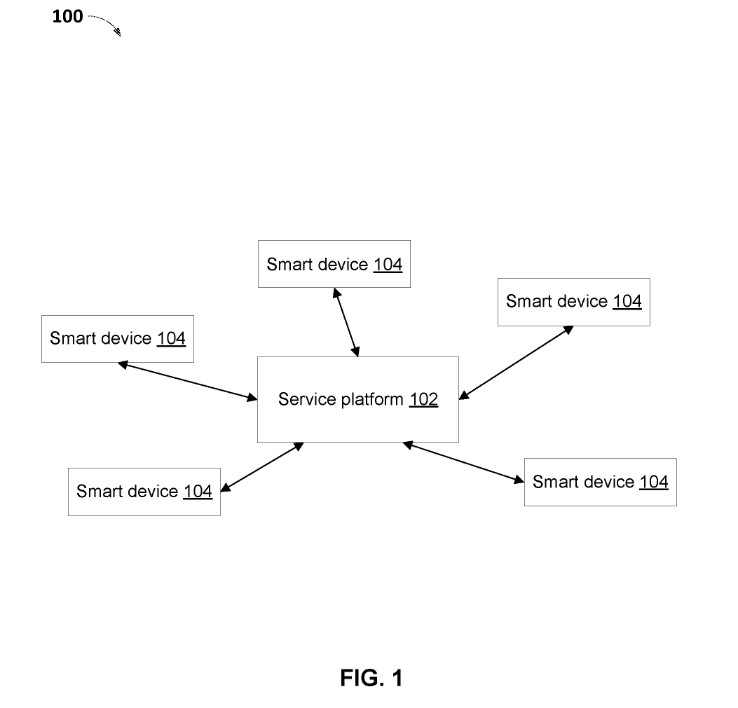

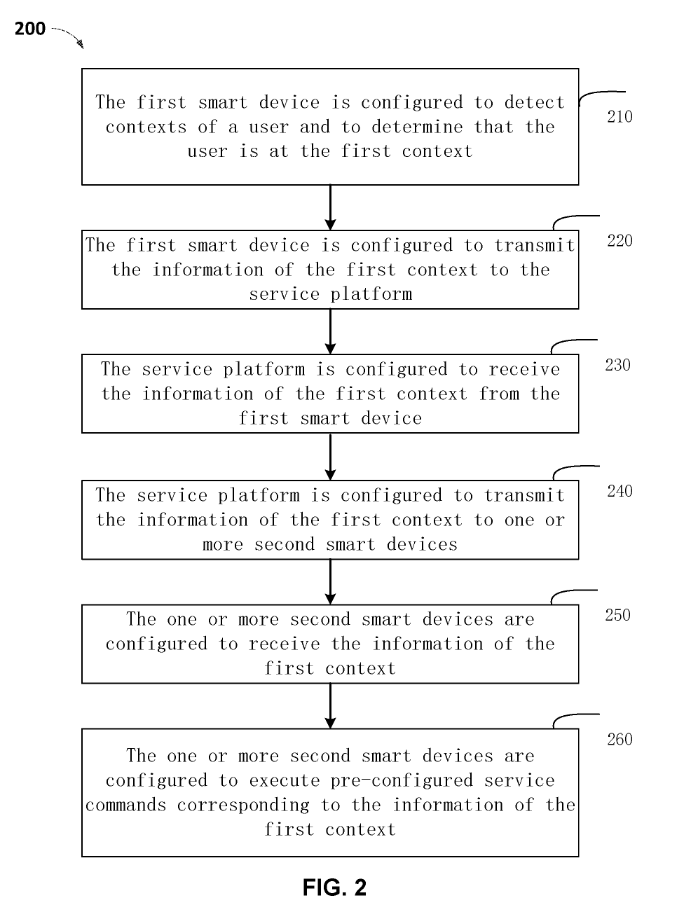

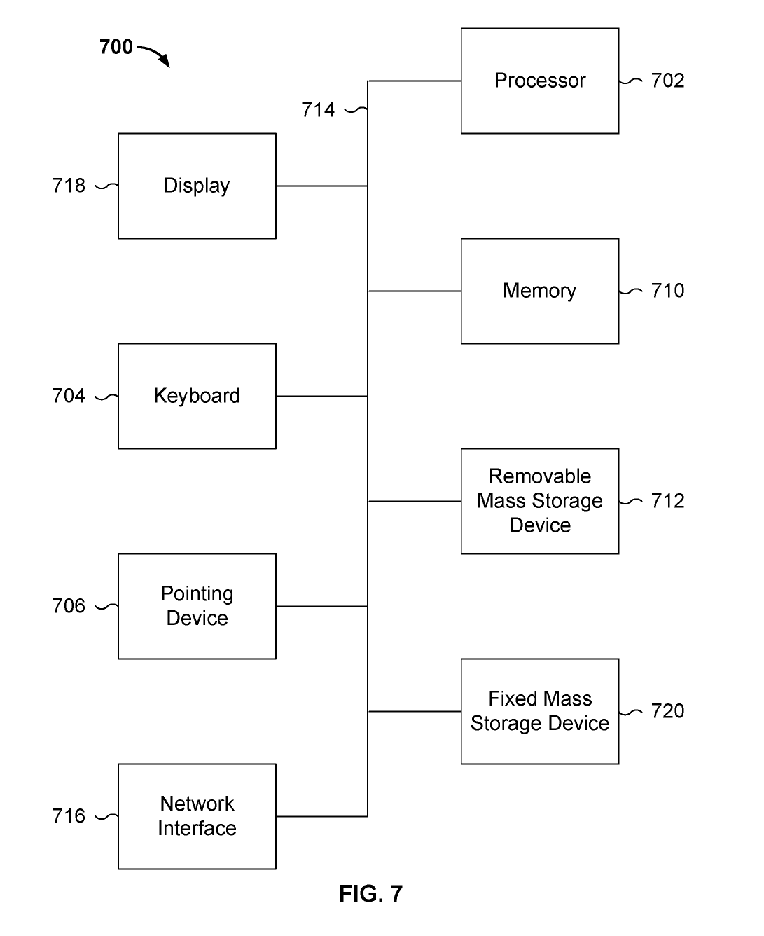

FIG. 1 illustrates an example system of providing context-based services in accordance with an embodiment of the present disclosure. System 100 includes a service platform 102, and a plurality of smart devices 104. Service platform 102 is a computing device that is configured as an information focal point for sharing and exchanging information amongst smart devices 104. Service platform 102 can include, for example, a smart phone, a notebook computer, a tablet computer, a personal computer, a server computer, a networking device such as a router or switch, and the like. Service platform 102 can also be implemented using a smart device that has sufficient computing resources to be designated as a service platform in addition to or separate from functioning as a smart device. More details are described with reference to FIG. 2. Further, service platform 102 can also be implemented by, for example, a computing system 700 of FIG. 7. In some embodiments, service platform 102 can be implemented at multiple computing devices, a cloud-based service, or a virtual machine distributed at various computing resources to achieve a scalable, adaptable, and load balanced architecture in terms of functioning as a central information hub.

Smart devices 104 include, for example, a mobile phone, a computer, a smart household device, a wearable device, a smart medical device, an in-vehicle device, or the like. Service platform 102 is configured to communicate with smart devices 104 via a wired or wireless network including the Internet, an intranet, a LAN, a WAN, a Bluetooth network, a ZigBee network, a Wi-Fi network, a WiMax network, an IR network, an RFID network, a Near Field network, or the like. Smart devices 104 can also be configured to be in communication with each other via the afore-described networks. Smart device 104 is configured to register its triggering contexts with service platform 102. For example, smart device 104 can be configured to inform service platform 102 of information such as the contexts in response to which smart device 104 is configured to execute service commands.

For simplicity of illustration, only one service platform 102 and five smart devices 104 are illustrated, and it should be understood that any number of service platform 102, and any number of smart devices 104 can be included in System 100.

FIG. 2 illustrates a flow chart of an example process for providing context-based services in accordance with an embodiment of the present disclosure. Process 200 can be implemented by, for example, system 100 of FIG. 1.

Process 200 starts at 210, where a first smart device is configured to detect the context that a user is currently at, and to determine that the user is in a first context.

In implementation, the first smart device can include a smart device 104 of FIG. 1. For example, the first smart device can include a smart wearable device, a smart phone, a notebook computer, a tablet computer, a desktop computer, or any device equipped with context-detecting functionalities.

In various embodiment, the first smart device can be implemented to employ any suitable techniques to obtain contextual information. The following illustrates three example mechanisms by which user contexts can be obtained by the first smart device.

With the first mechanism, the smart device is configured to detect the user's current operation behavior on the smart device, and subsequently determine the first context as the context corresponding to the operation behavior performed on the first smart device.

For an example where the first smart device is a notebook computer, the first smart device is configured to detect that the user is actively entering key strokes and various clicks on the menu items of the Microsoft WORD™ program installed thereon. Based on these contextual data detected from these example operations performed by the user, together with information such as, the time being 10:00 AM on Wednesday, or the user having been accessing company's internal reservoirs of documents and/or intranet web sites, or the user's calendar indicating Wednesdays as working from home days, or the user having logged in a virtual desktop environment of work, the smart device is configured to determine that the user is currently engaged with job related activities by the detection that the user is editing work related WORD documents. In other words, the first context is determined as user currently working.

For another example where the first smart device is a smart bracelet worn by the user, the first smart device is configured to detect contextual information including data related to the user's hand motion and/or patterns of the user's hand motion. Based on the detected contextual data matching a certain pattern (e.g., accelerometer data), the first smart device is configured to determine that the user is currently engaged in driving activities. In other words, the first context is determined as user currently driving.

For yet another example where the first smart device is a smart phone carried by the user, the first smart device is configured to detect contextual information including data related to the communicating modes and/or statuses of the user. The first smart device can be configured to detect that the user is making an outgoing phone call, accepting an incoming phone call, replying to a message using the SMS program, tweeting a post using the Twitter program, publishing a post on Facebook, participating in a group chat using the WeChat program, and the like. Based on these detected example communication activities, the first smart device is configured to determine that the user is currently engaged in a telephone call, in a messaging session, in social media communication session, etc.

With the second mechanism, the first smart device is configured to detect or obtain physical data or physiological data or the like related to a user of the first smart device, and subsequently to determine the first context as the context corresponding to the detected data.

For an example where the first smart device is a smart bracelet, the first smart device is configured to detect, among other aspects, physiological data such as the heart rate, blood pressure, breathing rhythm, and the like. Based on these detected example physiological information matching a certain threshold or pattern, the first smart device is configured to determine that the user is currently sleeping. In other words, the first context is determined as user currently sleeping.

With the third mechanism, the first smart device is configured to detect the environments or external conditions related to a user of the first smart device, and subsequently to determine the first context as the context corresponding to the environments or external factors.

For an example where the first smart device is a smart phone, the first smart device is configured to detect location information related to a user of the first smart device. Based on the detected location information matching the office location of the user, the first smart device is configured to determine that the user is currently at work. In other words, the first context is determined as user currently at work. For another example, the first smart device is configured to obtain weather reports and to determine that the temperature is extremely high. Further given the detection that the user is now outside of the office building, the first smart device is configured to determine that the user is currently experience high temperature. In other words, the first context is determined as the user being exposed to high temperature.

At 220, the first smart device is configured to transmit the information of the first context to a service platform. In some embodiments, the information of the first context is included in a notification to the service platform. In some embodiments, the information of the first context includes an identifier corresponding to the first context, and a description corresponding to the first context.

As the first smart device is configured to be in communication with the service platform via a communication network, the first device is able to transmit the information of the first context to the service platform. For example, the first smart device can be configured to transmit the information of the first context via a Bluetooth network or a local area network (e.g., by use of routers) to the service platform.

The first smart device can be implemented by one of smart devices 104 of FIG. 1. Therefore, in some scenarios, the first smart device is tasked with the context information obtaining functionality. In some other scenarios, the first smart device can also be tasked with the context information based service providing functionalities. In some embodiments, the first smart device is further configured to register with the service platform at least one contextual condition based on which a service of the first smart device is invoked. As such, when receiving contextual information from other smart devices, the service platform is configured to notify the first smart device of the occurrence of the context the first device has registered, and the first smart device in turn executes the service commands corresponding to the registered context. Further details are described in connection to a second smart device and with reference to step 250 below.

At 230, the service platform is configured to receive the information of the first context of the user transmitted from the first smart device.

In some embodiments, the first smart device is configured to transmit the information of the determined user context to the service platform. In some embodiments, the first smart device is also configured to transmit the entire or a portion of the detected contextual data with or without the information of the determined user context to the service platform. In the latter case, the service platform can be configured to, with the assistance of Artificial Intelligence (AI) or like technologies, determine the user's context based on the contextual data. Further, in the case where different smart devices have transmitted conflicting user context information, the service platform is configured to resolve the conflicting determination with references to factors such as priority level associated with the contextual data, timing information associated with the contextual data, and the like. In some embodiments, the service platform can be configured to restrict the forwarding of the context information based on pre-configured rules.

At 240, the service platform is configured to transmit the first context information to one or more second smart devices. The one or more second smart devices can be implemented by smart device 104 of FIG. 1. As the service platform is in communication with the second smart devices via a communication network, the service platform is configured to transmit the information of the first context via the communication network. In some embodiments, the service platform is configured to transmit the information of the first context to the second smart devices via a Bluetooth network or a local area network.

In some embodiments, the first and second smart devices are configured to be in communication with each other via a Bluetooth network, and the service platform is configured to support both a Bluetooth network interface and a local area network interface. As used herein, a Bluetooth network refers to both a Bluetooth Low Energy network, and a Bluetooth Classic network. In implementation, in order to be able to communicate with a variety of smart devices to obtain various user contexts, the service platform is configured to support both a Bluetooth Classic network and a Bluetooth Lowe Energy network. In scenarios where a smart device is designated as a service platform, the designated smart device is also configured with network interfaces that support both Classic Bluetooth and Bluetooth Low Energy protocols.

In some embodiments, a service platform is a mobile device such as a smart phone or a tablet computer. In some other embodiments, when not considering portability, the service platform is a notebook computer, a desktop computer, a set top box, an in-vehicle console, a server, or the like, delivering more computing resources and processing power in providing context-based services.

In some embodiments, the service platform is configured to record correlation relationships between the first smart device and at least one context in advance. The service platform is also configured to separately record correlation relationships between each of the one or more second smart devices and at least one corresponding context in advance. In some embodiments, the correlation relationships represent that one or more services provided at a second smart device that are triggered by the occurrence of the least one corresponding context. In some other embodiments, the correlation relationships represent that one or more services provided at a second smart device depend on, in addition to other triggering conditions, the occurrence of the at least one corresponding context. The correlation relationship is stored in a local table, a local database, a remote database, a cloud storage service, or the like.

Upon receiving the information of the first context from the first smart device, the service platform is configured to forward the information of the first context to those of the one or more second devices based on a match of the first context to the contexts registered in the correlation relationships. In other words, the service platform is configured to transmit the first context information to those second devices that have registered to be notified about the occurrence of the first context.

In some embodiments, when a relatively small number of the second smart devices are serviced by the service platform, the service platform is configured to transmit the information of the first context to all the second smart devices in communication, e.g., in a broadcast manner. This way, it is ensured that no second device will miss the first context information. Furthermore, sometimes a second smart device has updated its software or firmware from an old release to a new release, where the old release does not services in response to the first context, and the new release is able to provide services in response to the first context. Nevertheless, the second smart device has not yet registered the newly enabled context-aware capability with the service platform. As a result of the service platform being configured to transmit to all the second devices in communication, the afore-described second device is able to receive the first context information generated by the first smart device timely, regardless of the registration status with the service platform. As such, the second smart device is also able to act on the first context to provide the specific services timely.

In some embodiments, when the service platform detects that the first smart device has disconnected therefrom (e.g., the user together with the first smart device has moved outside of the communication range of the service platform), the service platform is configured to notify the one or more second smart devices to stop providing services to the user. This way, computing resources can be conserved by timely concluding the services.

At 250, the one or more second smart devices are configured to receive the information of the first context from the service platform.

The one or more second smart devices can include a smart wearable device, a smart phone, a notebook computer, a tablet computer, a desktop computer, a set top box, a server, a smart household appliance, and the like. More than one second smart device can be configured to provide services to a user at the same time.

At 260, the one or more second smart devices are configured to execute respective service commands corresponding to the first context information.

As described above, the second smart device is configured to register the information of the contexts based on which it is able to provide services with the service platform. Here, the one or more second devices have registered the first context information as the context to act upon with the service platform. As a result, upon receiving the first context information, the one or more second smart devices are configured to confirm that the first context is the context registered with the service platform, thereby retrieving respective service commands corresponding to the first context information, and executing the retrieved respective service commands to provide context-based services to the user. In the scenarios where a second smart device has newly acquired its first context based service capabilities without having registered with the service platform, the second smart device is configured to confirm that there have been changes relating to its context-based service capabilities (e.g., upgrades of software programs, etc.), and the first context is presently supported by the latest set of functionalities of the second device. In some embodiments, the second device registers the first context with the service platform at this point of time.

In some embodiments, after the second smart device detects that it has disconnected from the service platform (e.g., the service platform has moved out the service area or the communication range of the second smart device), the second smart device is configured to conclude the execution of the service based on the first context information. In some embodiments, the second smart device is also configured to receive from the service platform a notification that the first smart device has disconnected from the service platform (e.g., the first smart device has moved out of the communication range of the service platform), so that the second smart device concludes the execution of the service based on the first context information as well. As a result of being able to stop context-based services timely upon disconnection to the communication network, computing resources can be conserved in addition to providing context-based services efficiently and effectively.

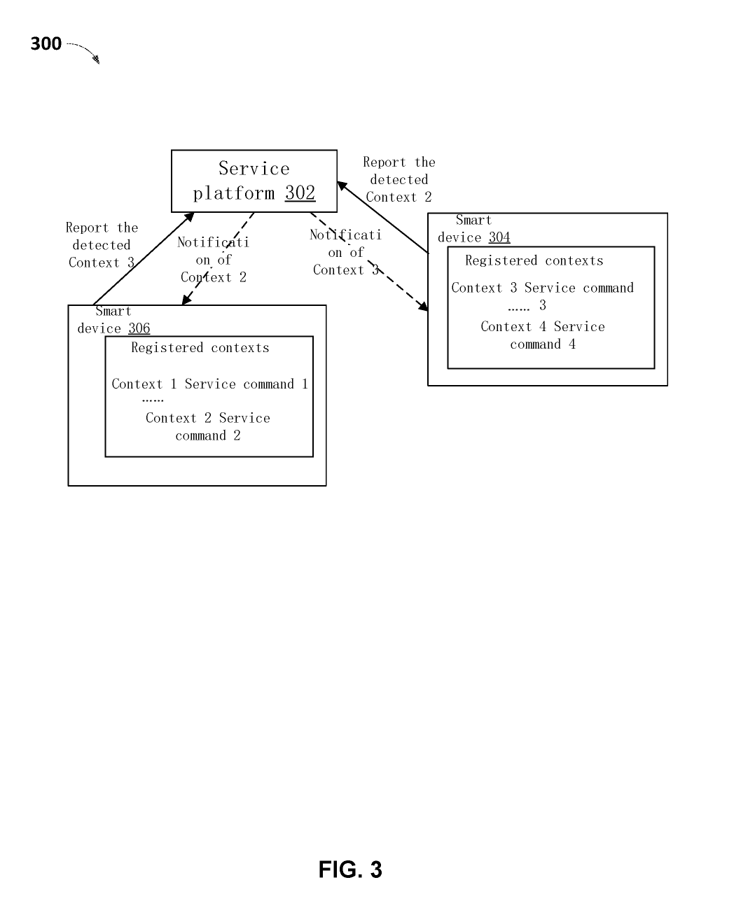

FIG. 3 illustrates a schematic diagram of an example of sharing contexts amongst smart devices in accordance with an embodiment of the present disclosure. System 300 includes a service platform 302, a first smart device 304, and a second smart device 306. System 300 can be implemented as system 100 of FIG. 1, e.g., service platform 302 can be implemented by service platform 102 of FIG. 1, while smart device 304 and smart device 306 can be implemented by smart device 104 of FIG. 1.

As shown herein, smart device 304 is configured to respond to Context 3 by use of Service Command 3, as well as Context 4 by use of Service Command 4. On the other hand, smart device 306 is configured to respond to Context 1 by use of Service Command 1, as well as Context 2 by use of Service Command 2. For the simplicity of illustration, smart devices 304 and 306 are only shown to provide services based on two contexts. It should be understood that system 300 can include any number of service platform 302, any number of smart devices 304 and 306, as well as providing services based on any number of contexts.

Additionally, smart device 304 is further configured to detect an occurrence of Context 2 (not shown), and subsequently to report the detected Context 2 to service platform 302. After Context 2 is reported to service platform 302, Context 2 is shared with smart device 306 by, for example, service platform 302 forwarding Context 2 to smart device 306. Smart device 306 accordingly invokes Service Command 2 pre-configured for Context 2 to provide Context 2-based services to the user. On the other hand, smart device 306 is configured to detect an occurrence of Context 3 (not shown), and subsequently to report the detected Context 3 to service platform 302. After Context 3 is reported to service platform 302, Context 3 is shared with smart device 304 by, for example, service platform 302 which forwards Context 3 to smart device 304. Likewise, smart device 304 accordingly invokes Service Command 3 pre-configured for Context 3 to provide Context 3-based services to the user. As such, even though a smart device is not configured to detect a particular user context, it can nevertheless timely provide services based on that particular context to the user by use of the contextual information shared from other smart devices capable of detecting that particular context.

By sharing detected contexts amongst smart devices, each smart device is configured to have access to more comprehensive user contexts such that more comprehensive, more timely, more customized, and more convenient context-based services can be provided to the user. As such, not only are context-based services provided with more efficiency and effectiveness, but also repeated context detection is avoided or reduced so as to decrease consumption of computing resources on smart devices.

For the purpose of illustration, example application scenarios involving smart devices and context-aware services are described in the following. It should be understood that embodiments of the present disclosure can be applied to any suitable applications without limitation.

In the first scenario, the first smart device is a smart phone, the second smart device is a smart TV set, and the user is in proximity of both first and second smart devices. In the beginning of the scenario, the user is watching TV programs aired on the smart TV set. Then the user picks up an incoming phone call at the smart phone. At this point, the smart phone is configured to transmit to a service platform a context information tagged as “ON_CALL,” indicating that the user is currently in a phone call conversation. In turn, the service platform is configured to forward the “ON_CALL” context information to the smart TV set, which has registered the context identified as “ON_CALL” with the service platform beforehand. By sharing the “ON_CALL” context with the smart phone, the smart TV set is also detecting that the user is currently engaged in a phone call. As such, the smart TV is triggered to execute a local service command of “SILENCE” corresponding to the “ON_CALL” context, putting itself in silent/muted mode while the user is speaking on the smart phone.

When the user ends the phone call, the smart phone is configured to detect that the user has hung up the phone from either the user's selection of the end of call button, or by detecting there is no longer an ongoing phone call session using the radio functionalities of the smart phone. As a result, the smart phone is configured to transmit the context information (“END_CALL”) to the service platform. The service platform is configured to forward the context identified as “END_CALL” to the smart TV set, which has registered the “END_CALL” context with the service platform in advance. After receiving the “END_CALL” context information, the smart TV set is configured to execute the service command of “NORMAL_VOLUME,” which is locally configured as the service command corresponding to the “END_CALL” context. As a result of executing the service command, the smart TV set unmutes itself and restores the volume to the normal setting.

Accordingly, the smart TV set is configured to become “smarter” by being able to tap into the user's communication context obtained by the smart phone, even though the smart TV set itself is not capable of detecting this type of user context. In this way, the services provided by the smart TV set are customized with further precision of the user's current context, and the services provided to the users are more convenient and effective.

In the second scenario, the first smart device is a smart bracelet, the second smart device is a smart air-conditioning system, and the user is wearing the first smart device while staying at a premise operated by the smart air-conditioning system.

When the user falls asleep, the smart bracelet is configured to detect that, for example, the heart rate has fallen below a certain level in addition to the body temperature also having fallen below a certain level. Based on the detected physiological data of the user, the smart bracelet is configured to transmit the context information “USER_SLEEP” to a service platform. In some other embodiments, the smart bracelet is configured to transmit a portion of the detected physiological data along with the “USER_SLEEP” information to the service platform, which is configured to confirm that “USER_SLEEP” is the correct user context based on other resources of information, or contextual data transmitted from other smart devices. The service platform is configured to forward the “USER_SLEEP” context information in turn to the smart air-conditioning system, which has registered the “USER_SLEEP” context information with the service platform in advance. This way the smart air-conditioning system is also configured to detect that the user is currently sleeping at this location. Accordingly, the smart air-conditioning system is configured to invoke the service command corresponding to the user being asleep, thereby automatically adjusting the air-conditioning system's mode to a sleeping mode.

Furthermore, for another example in the second scenario, the above-described smart TV set is also present at the premise where the user falls asleep. The service platform is also configured to forward the “USER_SLEEP” context information to the smart TV set, which has also registered with the service platform to receive the “USER_SLEEP” context information in advance. Likewise, the smart TV set can also detect that the user is currently sleeping by being able to access that particular context shared by the smart bracelet. Again, the smart TV set is triggered to invoke the service command pre-configured to respond to the “USER_SLEEP” context, thereby automatically turning itself off.

In the third scenario, the first smart device is a smart bracelet, the service platform is an in-vehicle Bluetooth system, the second smart device is a smart in-vehicle system, and the user wearing the smart bracelet is operating a vehicle equipped with the service platform and the second smart device.

When the user, without powering the vehicle off, moves away from the vehicle in by a certain amount of distance, the service platform is configured to detect that the smart bracelet is out of the communication range and thereof becomes disconnected thereto. Based on this, the service platform is configured to determine the current user context as a default “USER_LEAVE” context, and subsequently transmit the context to the in-vehicle system. In this case, the service platform transmits the “USER_LEAVE” context information to the smart in-vehicle system, regardless of whether the smart in-vehicle system has registered to receive the “USER_LEAVE” context. Then, the smart in-vehicle system is triggered to invoke the service commands locally pre-configured to respond to the “USER_LEAVE” context. As a result, the smart in-vehicle system powers the vehicle off, shuts the doors of the vehicle, and closes the windows of the vehicle to ensure that the vehicle power is not wasted, the vehicle battery power is not wasted on idling, and to avoid the potential problem that the user returns to a vehicle that is not able to be started due to power drain. Other appropriate actions can also be performed.

In some embodiments, a user or a group of users (e.g., the user and the user's family members, the user and the user's team members, an ad hoc assembly of users at a venue, etc.) owns multiple smart devices. In this scenario, one of these multiple smart devices is designated as the service platform servicing all the smart devices owned by the user or the group of users. In various embodiments, a smart device can be designated as a service platform using any suitable techniques. For example, smart device A can be configured to download and install the corresponding software application that is used to locally register the device information of the other smart devices connected to smart device A. The application is also used to record the respective operation statuses of the other smart devices connected to smart device A, for example, either as on-demand, periodically, or all the time. Afterwards, when smart device A and one or more of the other smart devices come within a certain distance from each other, smart device A is configured to trigger the monitoring of the statuses of those smart devices in the service range by use of the of above-described application. Once it is determined that a smart device has transmitted to smart device A a notification including contextual information, smart device A is configured to, based on the locally recorded device information of the other smart devices, transmit the contextual information to those smart devices that are connected thereto and have records matching with the contextual information. In some embodiments, smart device A is also configured to transmit the contextual information to all the member smart devices, e.g., in a broadcast method.

In another example, smart device A is configured to set up a group of smart devices, and designate itself as the service platform for the group of smart devices. Other devices are configured to request to join the group initiated by smart device A. In this case, smart device A is configured to collect the context information detected by other member devices in the group, and distribute the collected context information to the other member devices of the group. In some embodiments, the communication protocols and/or definitions of specific contexts used between smart device A and other smart devices of the group can be negotiated during the process of registration, or be configured by manufacturers (e.g., by use of pre-configured parameters or messaging formats).

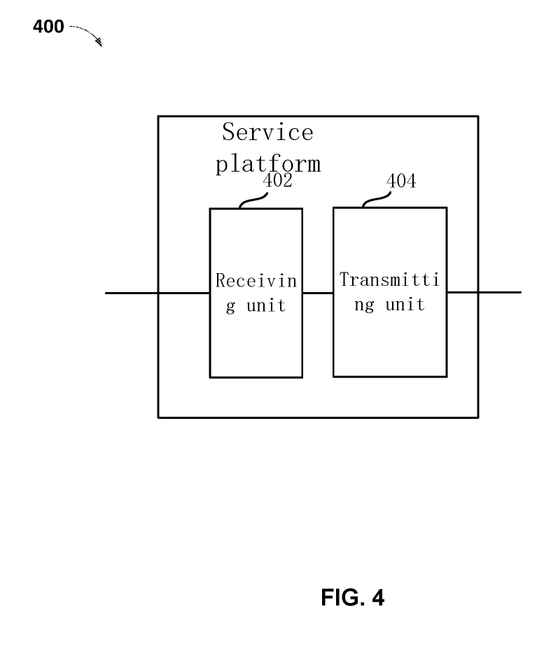

FIG. 4 illustrates a functional diagram of an example service platform for providing context-based services in accordance with an embodiment of the present disclosure. As shown herein, service platform 400 includes a receiving unit 402, and a transmitting unit 404. Most of the functionalities performed by receiving unit 402, and transmitting unit 404 are similar to those described above with references to FIGS. 1-3. Therefore, for simplicity of illustration, details of these functionalities are not repeated herein.

Receiving unit 402 is configured to receive a notification transmitted by a first smart device, the notification including the information of a first context of a user detected by the first smart device.

Transmitting unit 404 is configured to transmit the information of the first context to at least one second smart device. The at least one second smart device in turn is configured to execute a pre-configured service command corresponding to the information of the first context.

In some embodiments, service platform 400 is implemented at a smart phone, a notebook computer, a smart device, a tablet computer, a desktop computer, or the like.

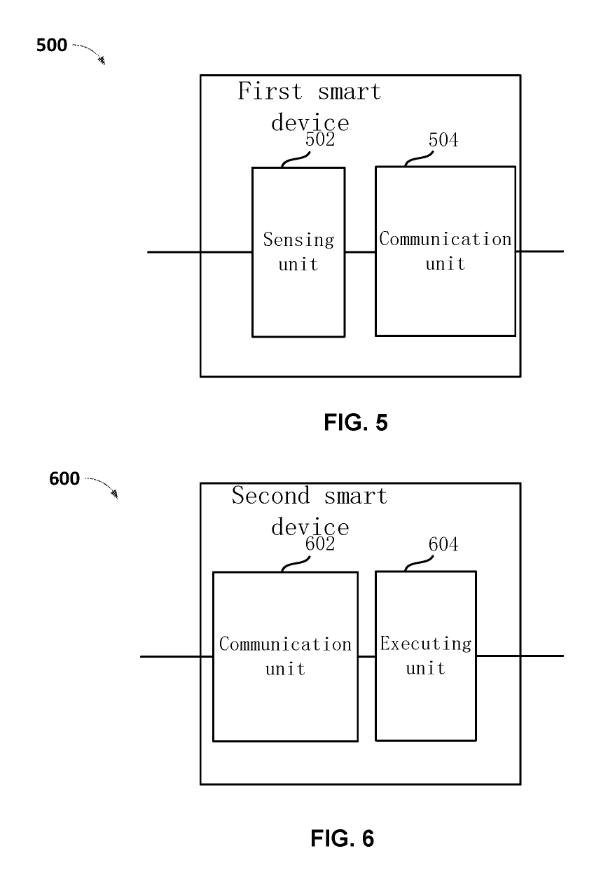

FIG. 5 illustrates a functional diagram of an example first smart device for providing context-based services in accordance with an embodiment of the present disclosure. First smart device 500 includes a sensing unit 502, and a communication unit 504. Most of the functionalities performed by sensing unit 502, and communication unit 504 are similar to those described above with references to FIGS. 1-3. Therefore, for simplicity of illustration, details of these functionalities are not repeated herein.

Sensing unit 502 is configured to detect the current context of a user and to determine that the user is at a first context.

Communication unit 504 is configured to communicate the information of the first context to a service platform, which in turn is configured to transmit the information of the first context to at least one second smart device. The at least one second smart device in turn is triggered to execute a pre-configured service commands corresponding to the information of the first context.

In some embodiments, first smart device 500 is implemented at a wearable smart device, a smart phone, a notebook computer, a desktop computer, or the like.

FIG. 6 illustrates a functional diagram of an example second smart device for providing context-based services in accordance with an embodiment of the present disclosure. Second smart device 600 includes a communication unit 602, and an executing unit 604. Most of the functionalities performed by communication unit 60 and executing unit 604 are similar to those described above with references to FIGS. 1-3. Therefore, for simplicity of illustration, details of these functionalities are not repeated herein.

Communication unit 602 is configured to receive information of the first context sent by a service platform. The information of the first context is obtained by the first smart device detecting the current environment of a user.

Executing unit 604 is configured to execute a pre-configured service commands corresponding to information of the aforesaid first context.

In some embodiments, second smart device 600 can be implemented at a wearable smart device, a smart phone, a notebook computer, a desktop computer, a smart home device, or the like.

FIG. 7 is a functional diagram illustrating an embodiment of a programmed computer system for providing context-based services. As will be apparent, other computer system architectures and configurations can be used to provide context-based services. Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general purpose digital processor that controls the operation of the computer system 700. Using instructions retrieved from memory 710, the processor 702 controls the reception and manipulation of input data, and the output and display of data on output devices (e.g., display 718). In some embodiments, processor 702 includes and/or is used to provide the launch of a client application based on a message.

Processor 702 is coupled bi-directionally with memory 710, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data, and objects used by the processor 702 to perform its functions (e.g., programmed instructions). For example, memory 710 can include any suitable computer readable storage media, described below, depending on whether, for example, data access needs to be bi-directional or uni-directional. For example, processor 702 can also directly and very rapidly retrieve and store frequently needed data in a cache memory (not shown).

A removable mass storage device 712 provides additional data storage capacity for the computer system 700 and is coupled either bi-directionally (read/write) or uni-directionally (read only) to processor 702. For example, storage 712 can also include computer readable media such as magnetic tape, flash memory, PC-CARDS, portable mass storage devices, holographic storage devices, and other storage devices. A fixed mass storage 720 can also, for example, provide additional data storage capacity. The most common example of fixed mass storage 720 is a hard disk drive. Mass storages 712, 720 generally store additional programming instructions, data, and the like that typically are not in active use by the processor 702. It will be appreciated that the information retained within mass storages 712 and 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display 718, a network interface 716, a keyboard 704, and a pointing device 706, as well as an auxiliary input/output device interface, a sound card, speakers, and other subsystems as needed. For example, the pointing device 706 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers. Persons skilled in the art may clearly understand that, for the sake of descriptive convenience and streamlining, one may refer to the processes in the aforesaid method embodiments that correspond to specific work processes of the systems, devices, and units described above. They will not be discussed further here.

In one typical configuration, the computation equipment comprises one or more processors (CPUs), input/output interfaces, network interfaces, and memory.

Memory may include such forms as volatile storage devices in computer-readable media, random access memory (RAM), and/or non-volatile memory, such as read-only memory (ROM) or flash memory (flash RAM). Memory is an example of a computer-readable medium.

Computer-readable media, including permanent and non-permanent and removable and non-removable media, may achieve information storage by any method or technology. Information can be computer-readable commands, data structures, program modules, or other data. Examples of computer storage media include but are not limited to phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digit multifunction disc (DVD) or other optical storage, magnetic cassettes, magnetic tape or magnetic disc storage, or other magnetic storage equipment or any other non-transmission media that can be used to store information that is accessible to computers. As defined in this document, computer-readable media does not include temporary computer-readable media, (transitory media), such as modulated data signals and carrier waves.

A person skilled in the art should understand that embodiments of the present application can be provided as methods, systems, or computer program products. Therefore, the present application can take the form of an entirely hardware embodiment, an entirely software embodiment, or an embodiment that combines software and hardware aspects. In addition, the present application can take the form of computer program products implemented on one or more computer-operable storage media (including but not limited to magnetic disk storage devices, CD-ROMs, and optical storage devices) containing computer operable program codes.

The present application is described with reference to flowcharts and/or block diagrams based on methods, devices (systems), and computer program products of embodiments of the present application. Please note that each process and/or block within the flowcharts and/or block diagrams and combinations of processes and/or blocks within the flowcharts and/or block diagrams can be realized by computer commands. These computer program instructions can be provided to general-purpose computers, special-purpose computers, embedded processors, or processors of other data-processing devices to give rise to a machine such that the instructions by the computers or by the processors of other programmable data-processing devices give rise to devices used to implement the functions specified in one or more processes in a flowchart and/or in one or more blocks in a block diagram.

These computer program instructions can also be stored in computer-readable memory that can guide computers or other programmable data-processing devices to operate according to specific modes, with the result that the instructions stored in this computer-readable memory give rise to products that include command devices. These command devices implement the functions specified in one or more processes in a flow chart and/or one or more blocks in a block diagram.

These computer program instructions can also be loaded onto a computer or other programmable data-processing device, with the result that a series of operating steps are executed on a computer or other programmable device so as to give rise to computer processing. In this way, the instructions executed on a computer or other programmable device provide steps for implementing the functions specified by one or more processes in a flow chart and/or one or more blocks in a block diagram.

Although preferred embodiments of the present application have already been described, persons skilled in the art can make other alterations and modifications to these embodiments once they grasp the basic creative concept. Therefore, the attached claims are to be interpreted as including the preferred embodiments as well as all alterations and modifications falling within the scope of the present application.

Obviously, a person skilled in the art can modify and vary the present application without departing from the spirit and scope of the present application. Thus, if these modifications to and variations of embodiments of the present application lie within the scope of its claims and equivalent technologies, then the present application intends to cover these modifications and variations as well.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for providing context-based services, comprising:
receiving, by a service platform, a notification from a first device, the notification including information of a context obtained about a user by the first device; and
transmitting, by the service platform, the information of the context to at least one second device such that the at least one second device is triggered to execute a pre-configured service command corresponding to the information of the context, the at least one second device being correlated to the information of the context.

2. The method of claim 1, wherein the service platform comprises one or more of: a smart phone, a notebook computer, a tablet computer, a smart device, a set top box, and/or a desktop computer.

3. The method of claim 1, wherein the information of the context comprises a context identifier, a content description of the context, or both.

4. The method of claim 1, wherein the service platform is configured to be in is communication with the first device and the at least one second device via a network including: a Bluetooth network, a ZigBee network, a Wi-Fi network, a WiMax network, an IR network, an RFID network, a Near Field network, or any combination thereof, and wherein the information of the context is transmitted over the network.

5. The method of claim 1, further comprising:
recording one or more correlation relationships between a second device of one or more second devices and information of at least one corresponding context; and
transmitting the received information of the context to the at least one second device based on the one or more correlation relationships.

6. The method of claim 1, further comprising:
notifying, upon detecting the first device being disconnected, the at least one second device to conclude the executing of the service command.

7. A method for providing context-based services, comprising:
detecting, by a first device, current contextual information of a user to determine a context of the user based at least in part on the detected contextual information; and
transmitting information of the determined context to a service platform, the service platform being configured to transmit the information of the determined context to at least one second device, wherein the at least one second device is triggered to execute a pre-configured service command corresponding to the information of the determined context.

8. The method of claim 7, wherein the first device comprises one or more of: a wearable device, a smart phone, a notebook computer, a tablet computer, an IoT device, and/or a desktop computer.

9. The method of claim 7, wherein the information of the determined context comprises a context identifier, a content description of the determined context, or both.

10. The method of claim 7, wherein the detecting current contextual information of the user to determine the context of the user based at least in part on the detected contextual information comprises one or more of:
detecting current operation behaviors of the user and determining the context based on the detected operation behaviors;
detecting current physiological data of the user and determining the context based on the detected physiological data; and/or
detecting current environmental factors of the user and determining the context based on detected environmental factors.

11. A system for providing context-based services, comprising:
one or more processors configured to:
receive, by a service platform, a notification from a first device, the notification including information of a context obtained about a user by the first device; and
transmit, by the service platform, the information of the context to at least one second device such that the at least one second device is triggered to execute a pre-configured service command corresponding to the information of the context, the at least one second device being correlated to the information of the context; and
one or more memories coupled to the one or more processors, configured to provide the one or more processors with instructions.

12. The system of claim 11, wherein the service platform comprises one or more of a smart phone, a notebook computer, a tablet computer, a smart device, a set top box, a desktop computer.

13. The system of claim 11, wherein the information of the context comprises a context identifier, a content description of the context, or both.

14. The system of claim 11, wherein the service platform is configured to be in communication with the first device and the at least one second device via a network including: a Bluetooth network, a ZigBee network, a Wi-Fi network, a WiMax network, an IR network, a RFID network, a Near Field network, or any combination thereof, and wherein the information of the context is transmitted over the network.

15. A system for providing context-based services, comprising:
one or more processors configured to:
detect, by a first device, current contextual information of a user to determine a context of the user based at least in part on the detected contextual information; and
transmit information of the determined context to a service platform, the service platform being configured to transmit the information of the determined context to at least one second device, wherein the at least one second device is triggered to execute a pre-configured service command corresponding to the information of the determined context; and
one or more memories coupled to the one or more processors, configured to provide the one or more processors with instructions.

16. The system of claim 15, wherein the first device comprises one or more of: a wearable device, a smart phone, a notebook computer, a tablet computer, an IoT device, and/or a desktop computer.

17. The system of claim 15, wherein the information of the determined context comprises a context identifier, a content description of the determined context, or both.

18. The system of claim 15, wherein the detecting current contextual information of the user to determine the context of the user based at least in part on the detected contextual information comprises one or more of:
detecting current operation behaviors of the user and determining the context based on the detected operation behaviors;
detecting current physiological data of the user and determining the context based on the detected physiological data; and/or
detecting current environmental factors of the user and determining the context based on detected environmental factors.

19. A computer program product, the computer program product being embodied in a tangible computer readable storage medium and comprising computer instructions for:
receiving, by a service platform, a notification from a first device, the notification including information of a context obtained about a user by the first device; and
transmitting, by the service platform, the information of the context to at least one second device such that the at least one second device is triggered to execute a pre-configured service command corresponding to the information of the context, the at least one second device being correlated to the information of the context.

20. A computer program product, the computer program product being embodied in a tangible computer readable storage medium and comprising computer instructions for:
detecting, by a first device, current contextual information of a user to determine a context of the user based at least in part on the detected contextual information; and
transmitting information of the determined context to a service platform, the service platform being configured to transmit the information of the determined context to at least one second device, wherein the at least one second device is triggered to execute a pre-configured service command corresponding to the information of the determined context.
